(19) United States
(12) Patent Application Publication
(10) Pub. No.: US 2008/0189604 A1
(43) Pub. Date: Aug. 7, 2008

(54) DERIVATIVE BLOG-EDITING ENVIRONMENT

(75) Inventors: Donald "Spike" Arthur Washburn, Bellevue, WA (US); Joseph James Allaire, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 11/627,732

(22) Filed: Jan. 26, 2007

(51) Int. Cl. G06F 17/00

(52) U.S. Cl. 715/255; 715/234

(57) ABSTRACT

Methods are described for editing a remote blog that has a certain appearance and includes identifying a remote location of the blog includes blog-rendering code (which may also include or be associated with formatting code), automatically creating a local instance of the blog-rendering code, and automatically utilizing the local instance to present an editing environment that substantially mirrors the appearance of the remote blog.

### INTRODUCTION

A blog (or “web log”) includes websites that are composed of blog posts (aka: entries). But adding new posts can be cumbersome and difficult because users are not presented with an editor that takes into account background and other formatting options (including imagery and other media components) of a remote blog when presenting a local editing environment. One of the problems associated with providing such an accurate editing environment is determining structured regions (such as a blog's title areas, body areas, e.g., blog-post title area, blog-post body area, and the like). Moreover, a framework in a blog-editing environment for exposing functionality of custom plug-ins does not exist.

Users who develop blogs may desire to insert feature-rich or complicated objects into their blogs. Users may also desire to extend the capability of their blog posts by making use of plugins that they develop or that are developed by third parties. Accordingly, the current state of the art could be improved by providing a framework and process for, among other things, allowing various plugins developed by various entities to be used to insert objects into blog posts. Moreover, efficiencies can be reaped by providing a first way of rendering and editable fragment of code that defines how an object is to be displayed in an editing environment, which is rendered in a second way in a published, or viewing, environment.

### SUMMARY

This summary is provided to introduce a selection of concepts in a simplified form that are further described below in the detailed-description section. The invention is defined by the claims below. But summarily, one embodiment of the invention provides a blog-editing environment that accurately presents an in-progress blog post the way it will appear when actually posted. Other embodiments are directed to determining structured regions, such as a blog's title section, its body section, etc. And still other illustrative embodiments are directed to a framework that allows developers to create plug-ins that offer certain functionalities and utilize those in a blog-editing environment.

### BRIEF DESCRIPTION OF THE SEVERAL VIEWS OF THE DRAWINGS

Embodiments of the invention are described in detail below with reference to the drawing figures, which form a part of this discourse, and are incorporated by reference herein, and wherein:

FIG. 1 depicts an illustrative operating environment suitable for practicing an embodiment of the invention;

FIG. 2 depicts components associated with a template file according to an embodiment;

FIG. 3 depicts a first method for editing a remote site according to an embodiment;

FIGS. 4A-4C depict other methods for editing a remote site according to other embodiments;

FIG. 4D depicts still another method for editing a remote site according to still another embodiment;

FIGS. 5A-10B are screenshots that depict various aspects of embodiments;

FIG. 11 depicts another illustrative operating environment suitable for practicing an embodiment;

FIG. 12 is a high-level flow chart of a process for providing plugin interoperability according to embodiments; and

FIG. 13 depicts an illustrative user interfaces provided based on a given plugin for receiving user settings that define certain characteristics of an insertion object according to an embodiment.

### DETAILED DESCRIPTION

Throughout the description, various embodiments of the invention and several acronyms and shorthand notations are used to aid the understanding of certain aspects of the invention. These acronyms and shorthand notations are intended for the purpose of providing an easy methodology of communicating the ideas expressed herein and are in not meant to limit the scope of the invention. The following is a list of these acronyms:

| Acronym/ | |
|---|---|
| Shorthand | Phrase |
| HTML | Hypertext Markup Language |
| CSS | Cascading Style Sheet(s) |
| Blog | blog or “web blog” (includes other |
| | types of electronic logs such as |
| | photoblogs, video logs, audio logs, |
| | and other types of social media |

Illustrative aspects of the invention will be described in greater detail below. Listing some aspects should not be construed as an indication that other aspects do not exist. But a select listing is provided for illustrative purposes.

In a first illustrative aspect, a method of editing a remote blog that has a certain appearance is provided. The method includes identifying a remote location associated with the blog that includes blog-rendering code, which includes formatting code, automatically creating a local instance of the blog-rendering code and a local instance of the formatting code, and automatically utilizing the local instance of the blog-rending code and the local instance of the formatting code to present a local instance of an editing environment that substantially mirrors the appearance of the remote blog.

In a second illustrative aspect, a method includes deriving an editing environment from a remote blog's appearance, automatically presenting the editing environment to a user such that user edits may be received and presented as they will appear when posted consistent with the certain appearance.

In a third illustrative aspect, a method includes identifying a remote blog site having a certain appearance, determining what information blog-rendering code is associated with presenting the blog site in such a way to have the appearance, utilizing the information to present an editing environment with a format that substantially corresponds to the appearance.

In a fourth illustrative aspect, a method includes providing a local blog-editing environment based on editing-environment rendering code and whose format is derived from a remote blog site, receiving an instantiation indication that indicates that a plugin is to be utilized, presenting a user interface that includes controls to receive settings from a user that define characteristics associated with an object associated with the plugin, receiving the settings, creating an editable code fragment that can be inserted into the editing-environment rendering code (wherein the editable code fragment provides an association with the plugin by way of a user-selectable rendering in the blog-editing environment), inserting the editable code fragment into the editing-environment rendering code; and presenting the user-selectable rendering in the blog-editing environment.

In a fifth illustrative aspect, a method includes providing an API that provides an interface between a blog-editing application and a plugin to extend functionality of the application, receiving an indication that the plugin is to be invoked, presenting a user interface based on the plugin to receive settings that define characteristics associated with an object to be rendered in a blog post, receiving the settings, creating an editable code fragment based on the settings that can be interpreted by the application to present a rendering associated with the plugin, and presenting the rendering in the blog-editing application, wherein the rendering is selectable and can re-invoke the user interface incident to a an indication of a desire to do so.

In a sixth illustrative aspect, a method includes presenting a rendering of an editable code fragment that is generated from user settings received by way of a user interface presented by a plugin associated with a blog-editing environment, receiving a command to publish a blog post composed by utilizing the blog-editing environment and containing the rendering, referencing the editable code fragment to determine programming logic necessary to render and object that includes any information associated with the rendering, and publishing the object in a blog post, wherein the object is associated with the logic to provide functional aspects associated with the object.

An embodiment of the invention may be described in the general context of computer code or machine-useable instructions, including computer-executable instructions, such as program modules, being executed by a computing device. Generally, program modules including routines, programs, objects, components, data structures, protocols, etc., refer to code that performs particular tasks or implements particular abstract data types. Embodiments of the invention may also be practiced in distributed computing environments where tasks are performed by remote-processing devices that are linked through a communications network.

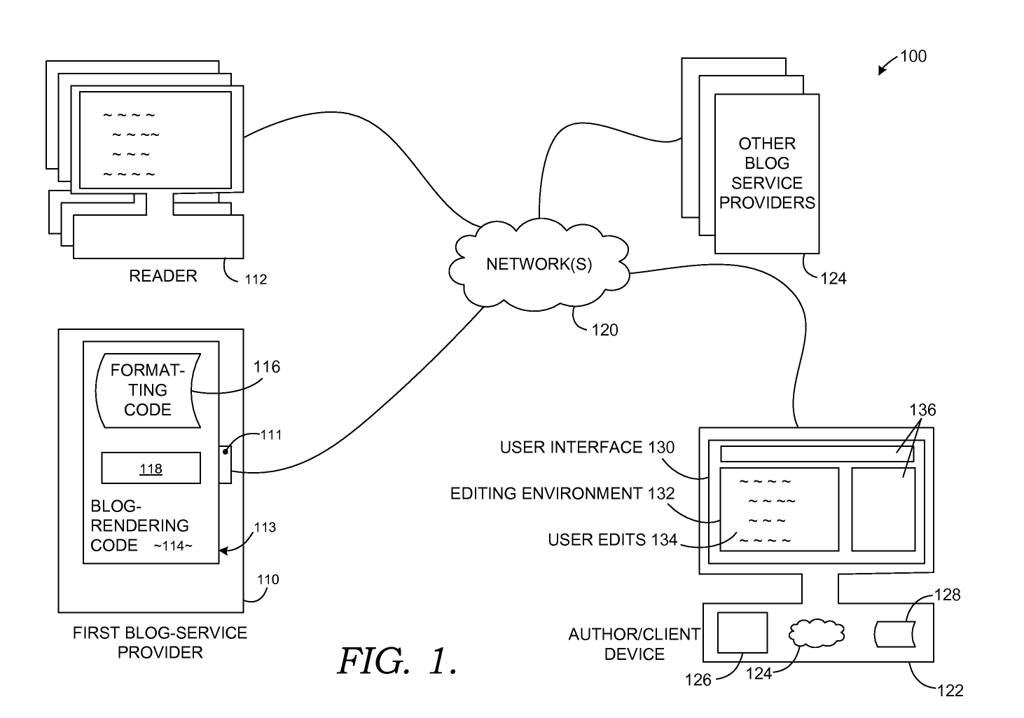

Turning now to FIG. 1, an illustrative operating environment suitable for practicing an embodiment of the invention is provided and referenced generally by the numeral 100. A first blog-service provider is depicted by numeral 110. A blog-service provider is any provider that provides the ability to create a blog. As previously mentioned, a blog, or “web log,” refers to website functionality that allows a user to memorialize thoughts, opinions, etc., in a diary-type format.

Blogs can serve a variety of purposes, for instance, personal or professional. That is, a blog may be developed for the purpose of providing news information, technical information, and the like, as opposed to only personal information. Illustrative blog-service providers include Wordpress (of Wordpress.org) and “Windows Live Spaces” of Spaces.live.com. The number of other blog-service providers are legion, and only a couple are referred to herein in an illustrative nature.

Blog-service provider 110 allows a blog to be accessed and read by a number of readers. A group of readers is illustratively shown by numeral 112. Readers may access blogs via a variety of devices, such as computers, smart phones, personal data assistants, and the like.

A blog provided by blog-service provider 110 is generally composed of blog-rendering code, which is referenced by the numeral 114. Blog-rendering code 114 describes how to render a blog so that it can be viewed by readers 112. In one embodiment, blog-rendering code 114 takes the form of HTML source code. Processing the HTML source code presents a blog to a reader. This obviates the need for a separate database or any sort of database reader, static or dynamic. The HTML source code itself is used. Thus, no control program is needed on the server 110 because the source code can be downloaded without one. According to embodiments, processing can be controlled by the client device 122.

Blog-rendering code 114 may include a variety of formatting informational items that provide a certain appearance of a blog. Thus, in one embodiment, blog-rendering code 114 includes formatting code 116. Formatting code 116 can take on a variety of forms. For example, formatting code 116 can include programmatic code segments that describe a background associated with a blog, formatting options associated with a font, style, paragraph, and the like, and much more. Although formatting code 116 is depicted in the way shown, it should not be construed from FIG. 1 that formatting code 116 is limited to being a portion of blog-rendering code 114. Indeed, it may be the case that certain formatting options may exist in a format or file external to blog-rendering code 114.

An illustrative example of a case where blog-formatting options are not completely subsumed in blog-rendering code 114 would be cascading style sheets, referred to as CSS. CSS files may be their own files in and of themselves. CSS files can include a variety of formatting options. For example, styles can be defined in CSS files such that certain styles take on various attributes based on certain events. For example, a certain style may have attributes that indicate what color or format a font should take when it is a hyperlink, or is a followed hyperlink, an item in a bulleted list, an item in a numbered list, a heading, etc. A cascading style sheet can describe attributes associated with an array of formatting options for various types of textual or other components. A number of CSS files may be associated with rendering a blog. These are not shown so as to not obscure the described methods and systems, but are fully contemplated within the scope of the claims below.

Another aspect of blog-rendering code 114 includes what we refer to as “structured regions.” These are represented by reference numeral 118. A structured region, variously referred to herein also as a “structured field” or “structured section,” that is usually associated with specific regions of a blog. For example, a first structured section may include a blog title. A second structured section may include a blog's body. Other structured regions may exist based on different types of blogs.

One or more networks 120 allow an author 122 to access blog-service provider 110, as well as other blog-service providers 125. Author 122 is represented by a client machine, which, as will be explained in greater detail below, downloads all or a portion of remote instances of blog-rendering code 114, formatting code 116, and other information associated with rendering a blog. Accordingly, an application 124 facilitates the downloading and provision of a local instance 126 of blog-rendering code 114 and a local instance 128 of formatting code 116 (as well as any other information pertinent to rendering a blog by provider 110).

As will also be discussed in greater detail below, application 124 utilizes local instances 126 and 128 to present a user interface 130 that includes an editing environment 132 that looks substantially similar to the way the blog provided by provider 110 looks. Editing environment 132 can be used to receive user edits 134. Various controls associated with applying various formatting options and performing various tasks such as publishing and updating local files are not shown in detail so as to not obscure the description herein, but are referenced generally by the numeral 136.

An API 111 is utilized in some embodiments to interface with and retrieve information associated with a blog offered by service provider 110.

As previously mentioned, one aspect of an embodiment includes downloading a copy of the source code associated with a web blog as well as other rendering information so that an editing environment can be created that substantially mirrors the appearance of the remote web blog 114. In one embodiment, editing environment 132 may make use of a template file to receive user edits.

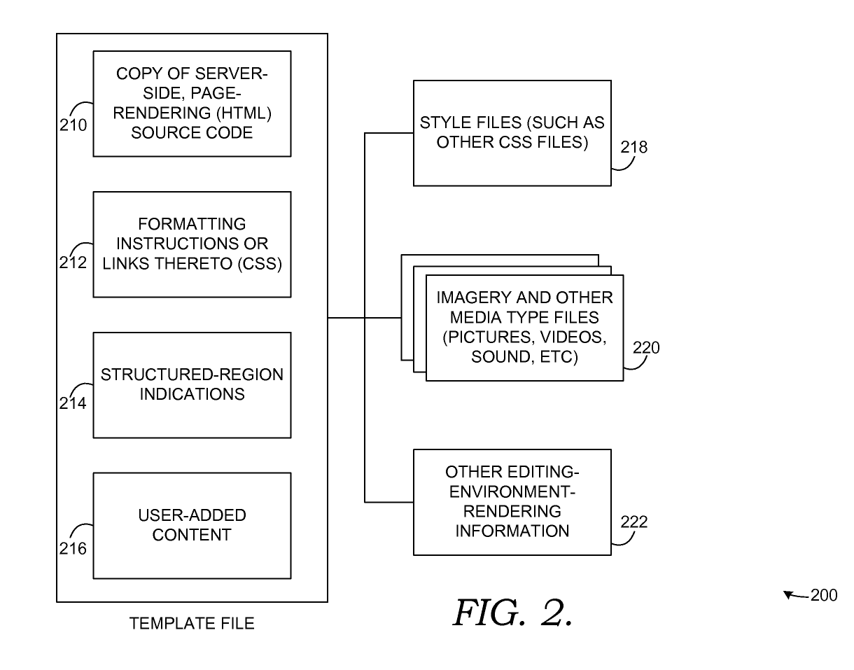

FIG. 2 depicts an illustrative template file, which is referenced generally by the numeral 200. Template file 200 may include a copy of all or a portion of server side, page-rendering source code, such as HTML 210. In one embodiment, formatting instructions or links to the same are also included. These are referenced by numeral 212. Structured-region indications 214 may also compose part of template file 200. This is also meant to indicate the actual structured regions themselves, which are sections defined by certain structured-region indications. User-added content 216 represents content that a user adds. For example, a user may post text, pictures, and the like. Template file 200 may be associated with other files, such as other style files 218. These other files 218 may include other CSS files; that is, other cascading style sheets.

Moreover, imagery and other media file types 220 may also be associated with template file 200. Illustrative media file types may include pictures, videos, sound, and the like. In some instances, the data associated with these files is not subsumed within the actual source code of a file. For example, a picture may just be a stand-alone file. But according to an embodiment, it is desirable to depict a picture in the same way that the picture is depicted remotely. Thus, the template file 200 will link to and present imagery 220 so that the appearance in editing environment 132 is the same as that of remote blog 113. Other editing-environment rendering information is referenced by numeral 222. This other information 222 may include any other type of information associated with rendering a blog, or presenting it in a certain way.

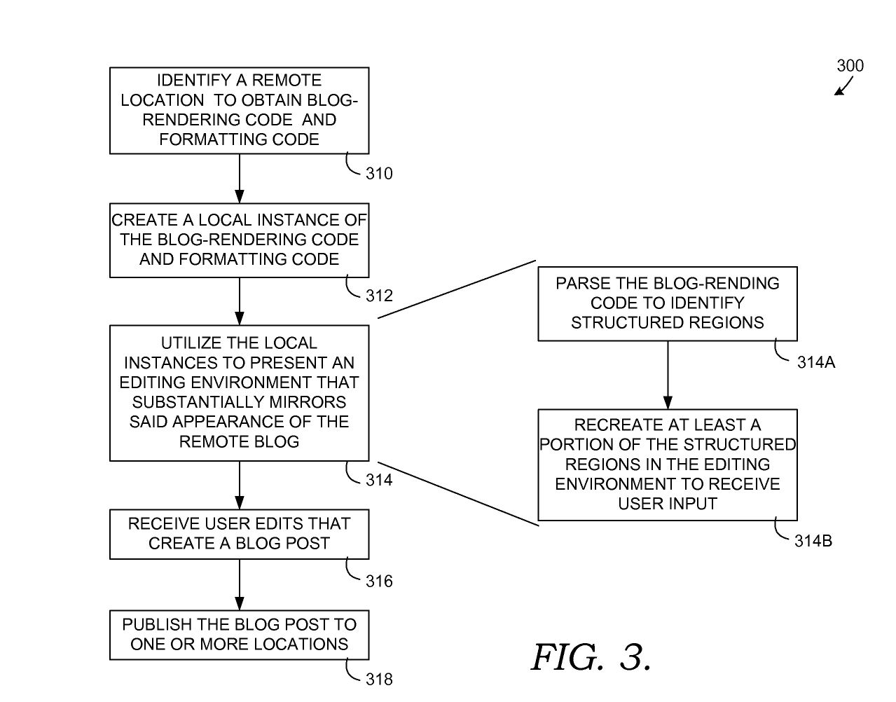

Turning now to FIG. 3, an illustrative method according to an embodiment for recreating a local environment that is substantially similar to how a blog post will actually be presented remotely is provided and referenced generally by the numeral 300. At a step 310, application 124 identifies a remote location that can be used to obtain blog-rendering code and formatting code. In one embodiment, the remote location (e.g., a blog, wiki, or the like) may be identified by a URL, such as the URL of a person's blog site. A wiki is a website that allows visitors add, remove, and otherwise edit content, normally without the need for registration. Thus, in one embodiment, a person's blog homepage can be utilized as a location identifier.

Another option for providing access to desired blog-rendering and formatting options is to utilize a roll-up page. A roll-up page may include a blog homepage, but it may also include other information. In still another option, a generic homepage may provide the source for determining blog-rendering code 114 or formatting code 116. In such an instance, multiple components may appear on a person's homepage. For example, a user may include a photo album, access to pictures, weather reports, favorite links, and a blog. In this example, the blog portion of the website is identified, and information associated with rendering a blog is also identified. This may include taking advantage of still another option for gathering blog-rendering information.

This final illustrative method may include piercing one or more levels of an entry page to reach a single blog post. In such situations, a perma-linked page may correspond to a specific blog post. A perma-linked page is a page associated with a unique URL. If this unique URL is entered or requested by a web browser, it will always reference the same location. Some blog sites offer an introductory page, and then invite users to follow a link to access a user's blog or more information associated with the user's blog. One of the goals of application 124 is to be able to identify various formatting options and rendering code associated with a blog. Along those lines, accessing a page that is associated with only a single blog post may be advantageous in some situations. As such, an embodiment of the invention contemplates accessing such a page.

At a step 312, a local instance of the blog-rendering code, formatting code, and any other information 222 associated with rendering a blog is downloaded. We will refer to blog-rendering code 114 with the intent of conveying the concept that all information associated with rendering a blog is captured by referring only to blog-rendering code 114. That is, for ease of explanation, we will not always distinguish formatting code 116 from blog-rendering code 114; or structured sections 118 from blog-rendering code 114, or other editing-environment-rendering information 222 from blog-rendering code 114. When we mention blog-rendering code 114, we mean to describe all or a portion of the aforementioned information for the sake of simplicity and so as to not obscure the disclosure.

In some embodiments, it is expedient to have a completely local representation of remote files that will be utilized to generate editing environment 132. In those situations, other supporting files such as imagery 220 or other style sheets 218 are also downloaded. In one embodiment, references in blog-rendering code 114 to remote files can be replaced with references to their now-corresponding local files (e.g., 126, 128, and other local files not shown). That is, if information to render a picture first referenced a remote file, that reference will be replaced with a reference to a local file in this embodiment. In other embodiments, although local instances of blog-rendering code 114 are downloaded, the references to other remote files may remain intact to ensure that editing environment 132 is completely up to date because it will be updated as soon as any remote files are updated.

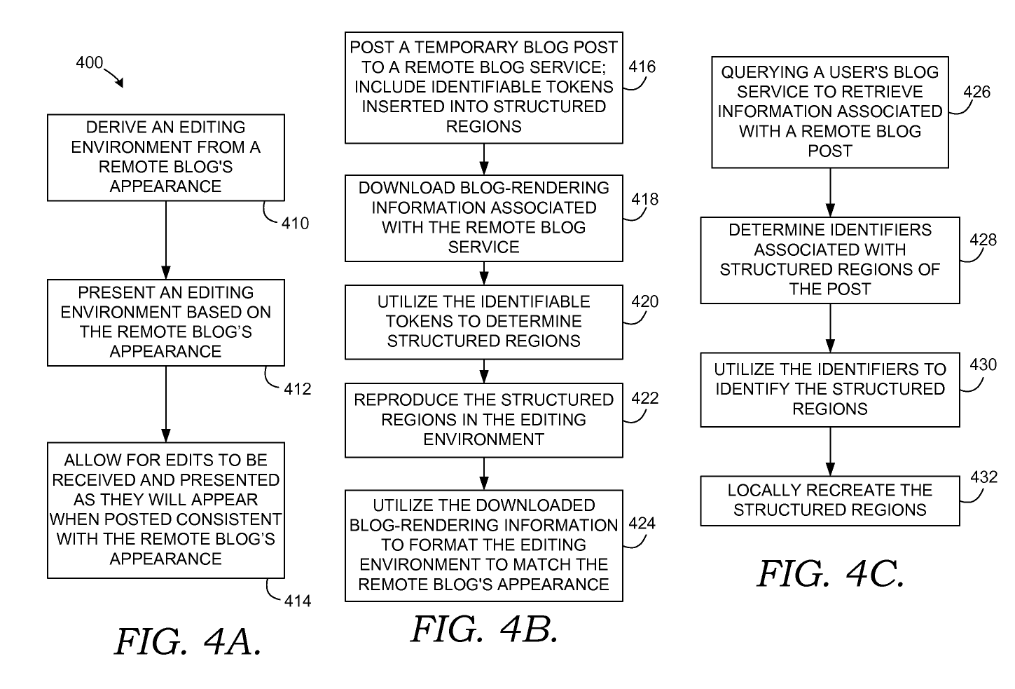

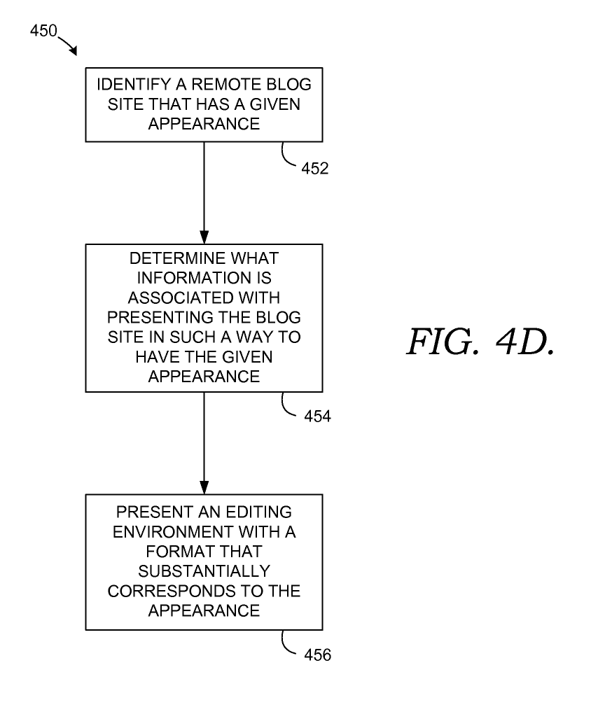

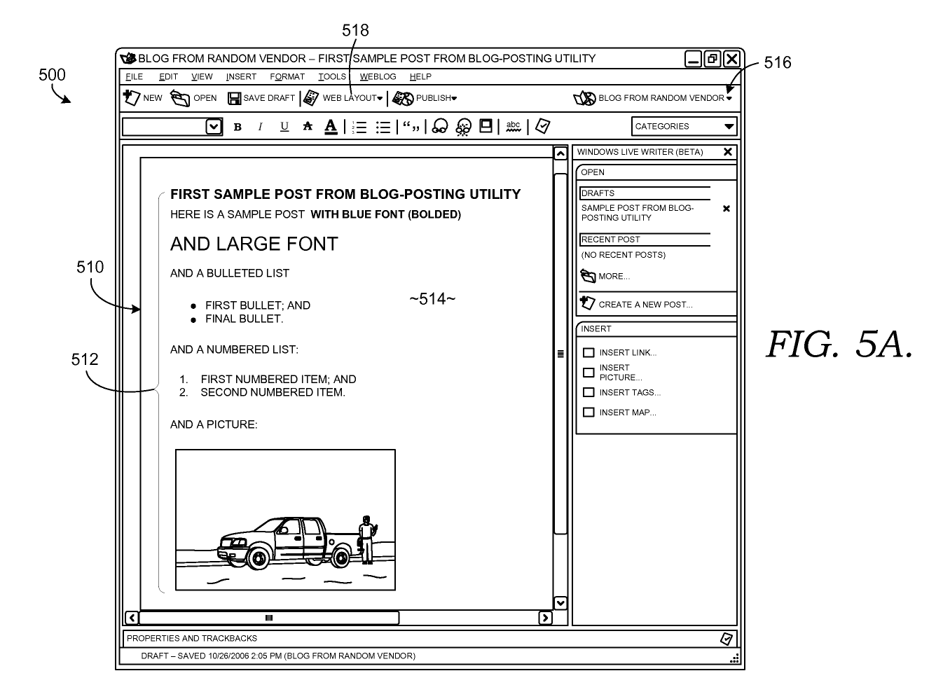

At a step 314, the local instances of the downloaded files are utilized to present an editing environment 132 that substantially mirrors or corresponds to the appearance of the remote blog 113. One aspect of this step includes identifying the structured sections and then preparing those structured sections to be presented in editing environment 132. We will describe various ways of identifying the structured regions in connection with FIG. 4B, FIG. 4C, as well as other text herein.

One method of identifying structured regions is to parse the blog-rendering code at a step 314A. The code is parsed to identify certain known tags or key words associated with structured regions 118. These regions are identified, and any text that appeared in them is deleted, so that at least a portion of the structured regions are prepared to receive user input at a step 314B. Rather than a web browser, application 124 can make use of the HTML source code to present an editing environment that is substantially similar to that of the remote web log.

At a step 316, user edits are received by application 124. If a user desires, the blog post may be posted to one or more locations at a step 318. When the blog post is published to a remote provider such as first blog-service provider 110, the remote post will appear in a format very similar to how it appeared in editing environment 132. Application 124 may also be configured to automatically publish the post to multiple service providers 124. In such a situation, formatting information associated with each respective service provider will be utilized so that the corresponding formatting of each respective service provider will be utilized.

Turning now to FIG. 4A, another illustrative embodiment is provided and referenced generally by the numeral 400. At a step 410, an editing environment, such as editing environment 132, is derived from a remote blog's appearance. At a step 412, an editing environment 132 is presented to a user that looks substantially to or identical to the remote blog's appearance. And at a step 414, application 124 presents editing environment 132 to receive user edits and present them in a way that they will appear when posted, and reflected in remote blog 113. FIGS. 4B and 4C flesh out aspects associated with deriving an editing environment from a remote blog's appearance.

Turning now to FIG. 4B, at a step 416, application 124 posts a temporary blog to a remote blog service that includes identifiable tokens that are inserted into known structured regions. An identifiable token can be any character string or text string that is known to be unique and that can be used to identify the structured regions or sections. For example, application 124 may publish a temporary post with the phrase “penny one two three” as a title and “penny four five six” as a message body. When the HTML is later analyzed, the two phrases can be searched on to determine the respective regions.

At a step 418, blog-rendering information associated with the remote blog service is downloaded. At a step 420, the identifiable tokens of step 416 are used to determine the structured regions as previously mentioned. A search can be done to locate the identifiable tokens in the HTML source code because the tokens were provided by application 124. Thus, application 124 is able to determine the structured regions. Thus, at a step 422, application 124 reproduces the structured regions in editing environment 132. The downloaded blog-rendering information is used to format editing environment 132 to match that of the remote blog's appearance at a step 424.

Turning now to FIG. 4C, an alternative method for determining structured sections or regions is provided. At a step 426, application 124 queries the user's blog service to retrieve information associated with a remote blog post. In this embodiment, API 111 can be utilized to request information associated with a blog. Illustrative information requested for may include the most recent blog post. The return product of such a request may include a file pre-parsed to denote such structured regions as a body, title, author, publish date, and other categories.

For example, in some embodiments, an XML file is returned that includes such information and denotations of such information. In this way, the text returned associated with an identifiable region is now known and can be used to search the source code to locate the structured regions in the source code. Accordingly, at a step 428, application 124 determines identifiers that are associated with the structured regions of the post. At a step 430, application 124 utilizes those identifiers to identify the structured regions, so that they can be locally recreated at a step 432. The locally recreated structured regions are then presented to a user and user interface 130 as part of editing environment 132.

FIG. 4D depicts still another embodiment for recreating a blog-editing environment based on a remote blog-editing environment, and is referenced generally by the numeral 450. At a step 452, a remote blog site 113 is identified that has some given appearance. At a step 454, a determination is made as to what information is associated with presenting the blog site in such a way to have that given appearance. And at a step 456 that information is utilized to present an editing environment with a format that substantially corresponds to the given appearance of step 452.

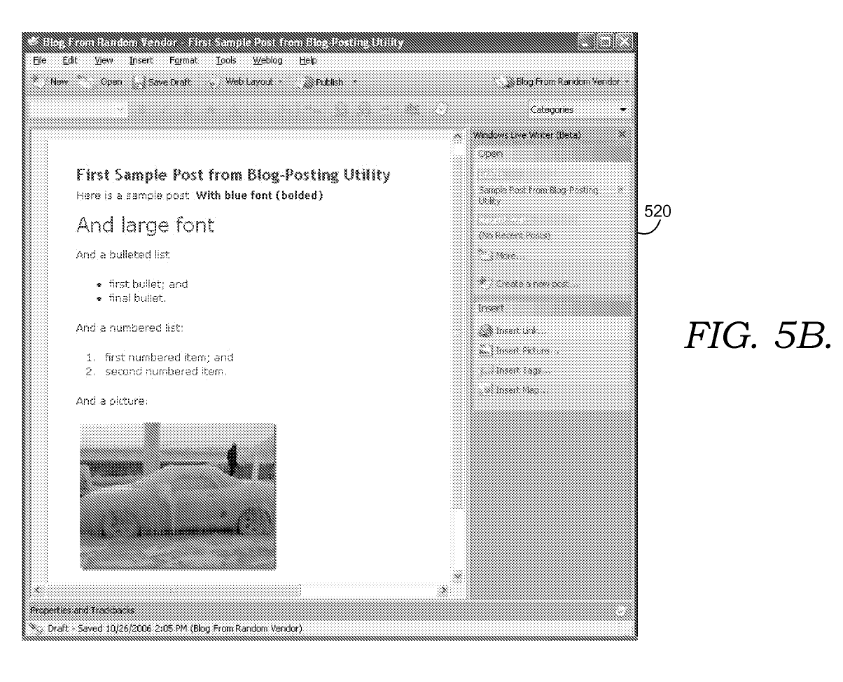

Turning now to FIG. 5A, an illustrative screenshot depicting an embodiment of information presented via user interface 130 is provided and referenced generally by the numeral 500. Editing environment 510 is an illustrative example of what editing environment 132 might include. Similarly, a set of user edits are indicated by numeral 512, which may be similar to the user edits referred to in FIG. 1 by numeral 134. As shown, the user edits may include a variety of different fonts and paragraphs and styles and imagery and other media files not shown. A background 514 is shown, but does not include any special formatting at this stage. The remainder of what is shown by drawing 5A is fully contemplated to as disclosure in this document.

But each and every button and option is not explained because one of ordinary skill in the art would understand functional aspects offered by the buttons and references incident to seeing them in the form they take in FIG. 5A. As can be seen from screenshot 500, options are provided to open a file, create a new file, view drafts of previous posts, create a new post, insert links, insert pictures, insert tags, insert a map, etc. As shown, this would enable selecting a different service provider 124 would be as simple as selecting an option from dropdown 516.

Similarly, alternative layouts may be selected by selecting an option referenced by numeral 518. Different layouts may include a layout as shown in editing environment 510 that has clutter removed, wherein some may view clutter to include navigation options, and other options unique to the specific blog-service provider. But a picture-perfect preview may also be accessible via button 518, which would present a preview of the blog post in precisely the same format as it would appear once remotely posted. In FIG. 5B, screenshot 520 is an actual screenshot of the drawing in FIG. 5A.

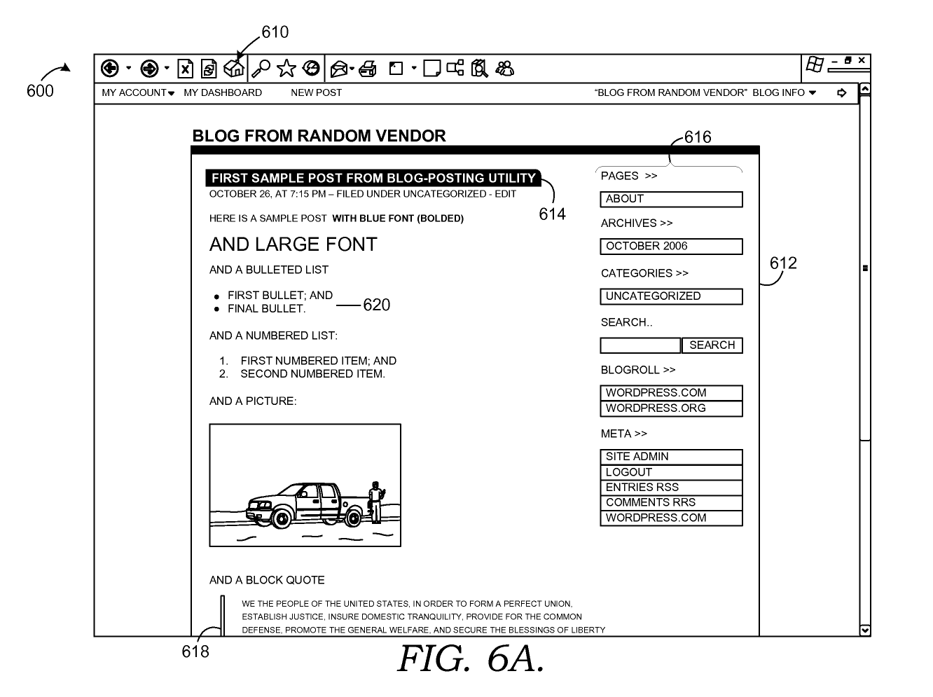

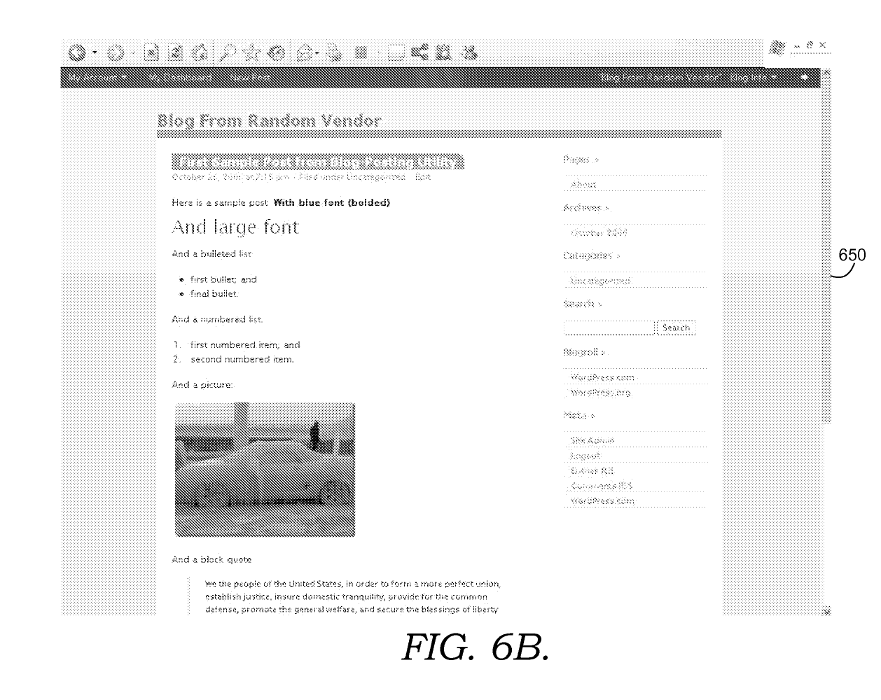

Turning now to FIG. 6A, a screenshot 600 is shown, which depicts a web browser 610 rendering the blog post of FIG. 5A except for formatting changes. For example, a user may have navigated to a blog-service provider and selected an option that allowed a theme to be applied to the blog post. Here, the blog-presentation region 612 depicts the blog with various changed formatting options. For example, the title 614 is shown to be presented with a backlit color. Illustrative options shown by numeral 616 represent the type of options that can be removed when presented in a local editing environment such as editing environment 132.

But in the picture-perfect preview, even these options can be presented to a user to see a precise rendition of what the blog post will look like. Some formatting changes are present, but may not be readily apparent due to the limitations of drawing figures in a patent application, but FIG. 6A depicts a vertical bar 618 that has a specific format and color. If hyperlinks or other types of formatting were applied to elements in blog post 612, then they will ultimately be reflected in an updated blog-editing environment, which we will describe below. FIG. 6B depicts an actual screenshot 650 of drawn FIG. 600.

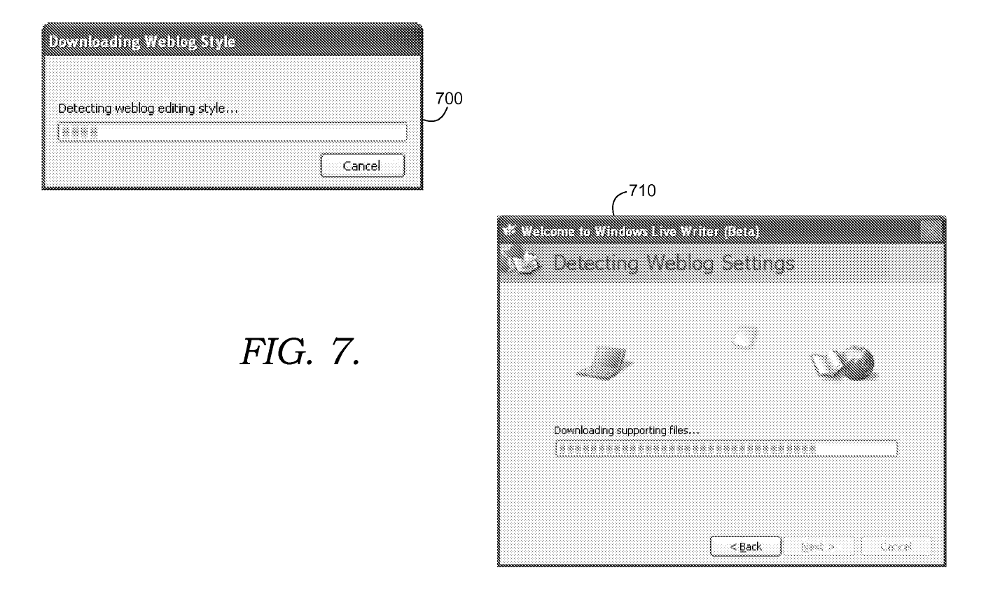

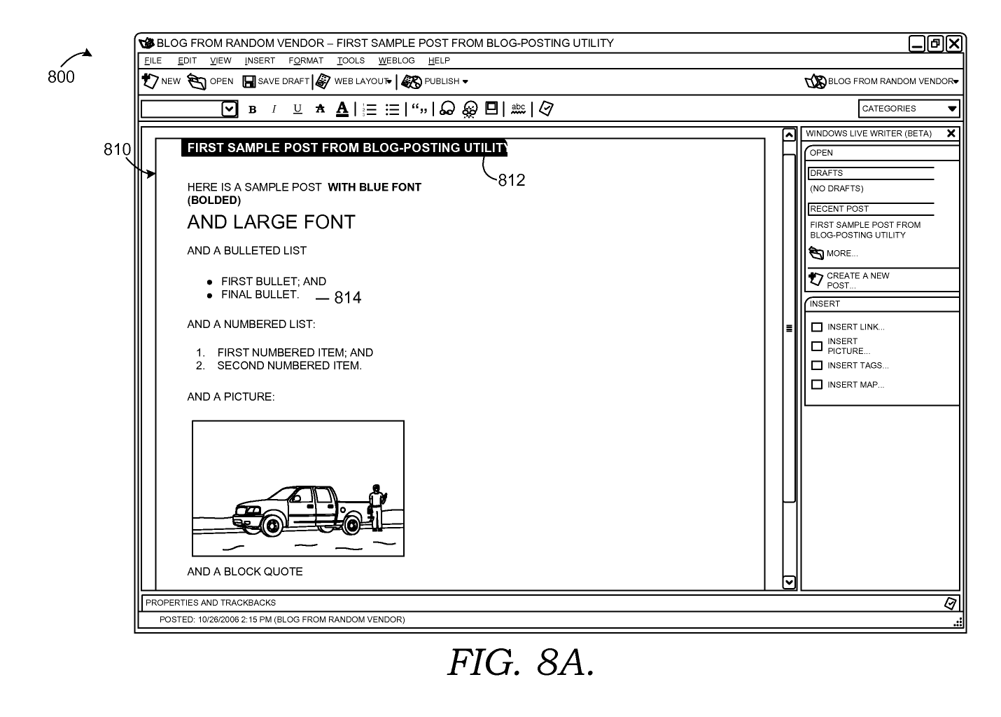

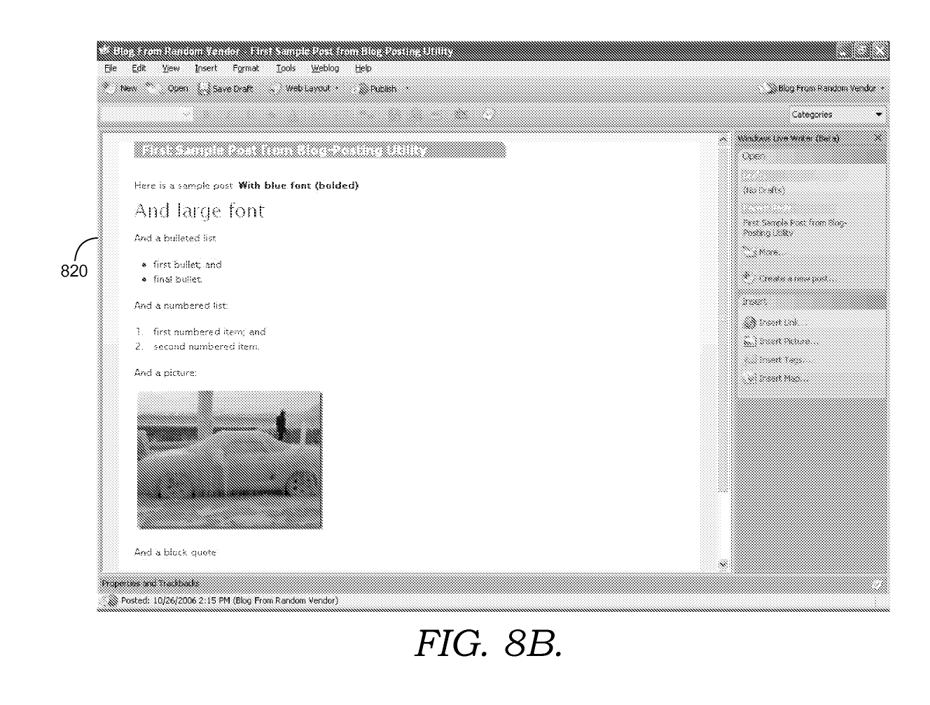

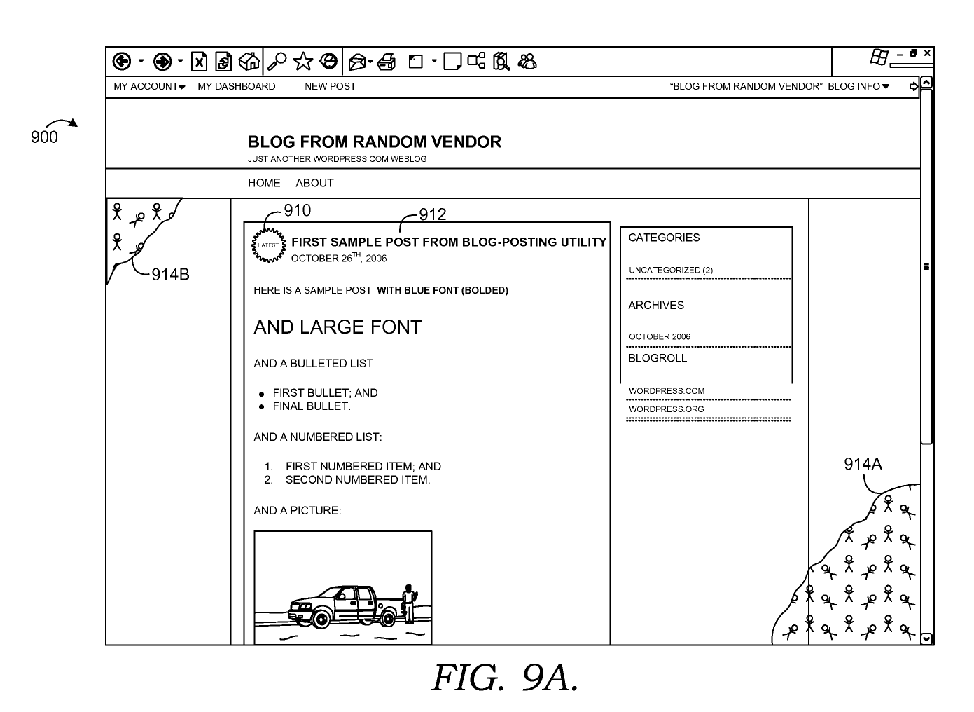

After a user selects to vary the formatting options associated with a remote blog 113, he or she can select an option to update the local blog-rendering settings, or this task can be performed automatically. FIG. 7 depicts illustrative screenshot 700 and 710 that depicted processes associated with application 124 automatically detecting new web log editing styles, source files, and other information so as to present an updated editing environment, which is depicted in FIG. 8A.

FIG. 8A includes a screenshot 800 with an updated editing environment 810 that substantially mirrors the formatting of remote blog post 612 shown in FIG. 6A. As can be seen, title 812 now has a formatting that matches the formatting of title 614 of FIG. 6A. If the background or other items in FIG. 6A were updated, those corresponding items would also be upgraded. For example, if bulleted list 620 of FIG. 6A included special bullets wherein the bullets corresponded to images, then the bulleted list 814 in FIG. 8A would be updated to correspond to those special bullets. And although not shown, the horizontal bar of FIG. 618 would also be reflected in the local editing environment 810 of FIG. 8A. FIG. 8B depicts an actual screenshot 820 of drawing 800 in FIG. 8A.

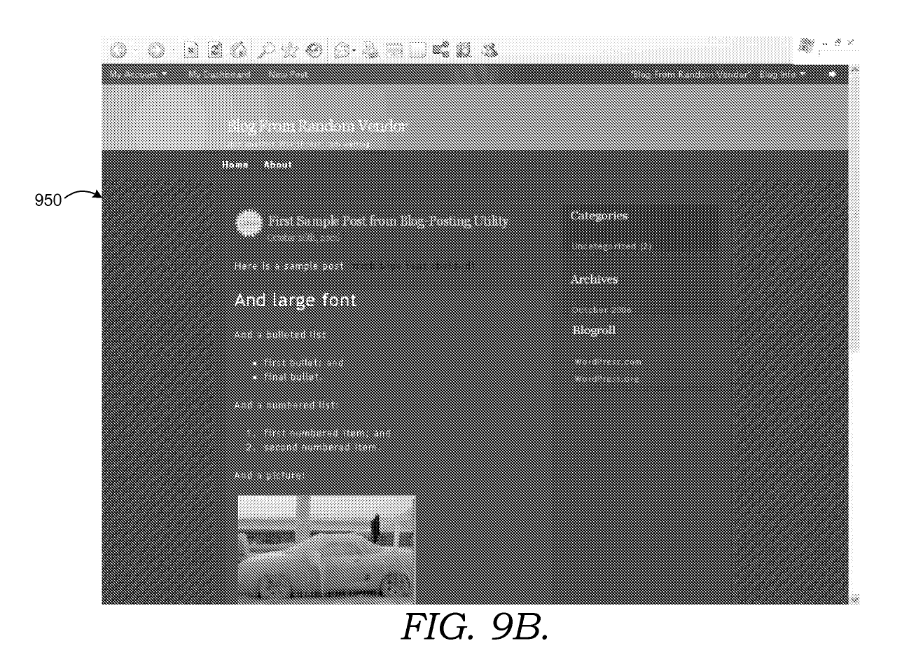

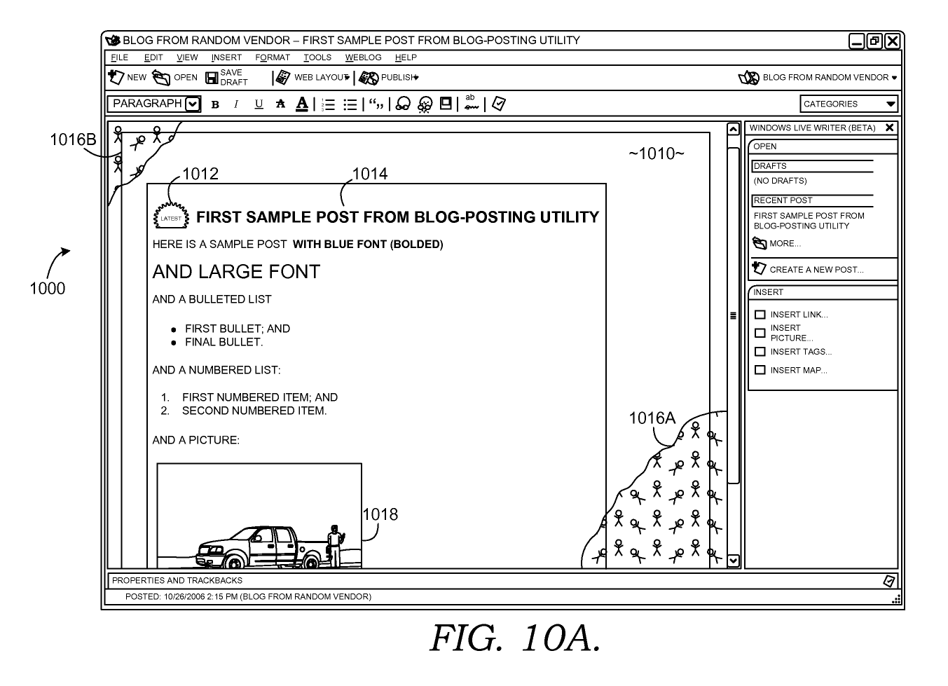

If the user decided to change the formatting options yet again on his or her remote blog site, then he or she could do this at the remote blog site, or if application 124 included the functionality, to remotely indicate a desire change. FIG. 9A depicts a screenshot 900 wherein the user has done just that: Selected still a different theme or other formatting options to be applied to his or her blog. As can be seen, a piece of art 910 is depicted next to a revised title 912. Moreover, an entire background represented by numerals 914A and 914B indicate that another color or type of shading, or other formatting option has been applied to the background of the blog post shown in screenshot 900. FIG. 9B depicts an actual screenshot 950 of the drawn screenshot in FIG. 9A.

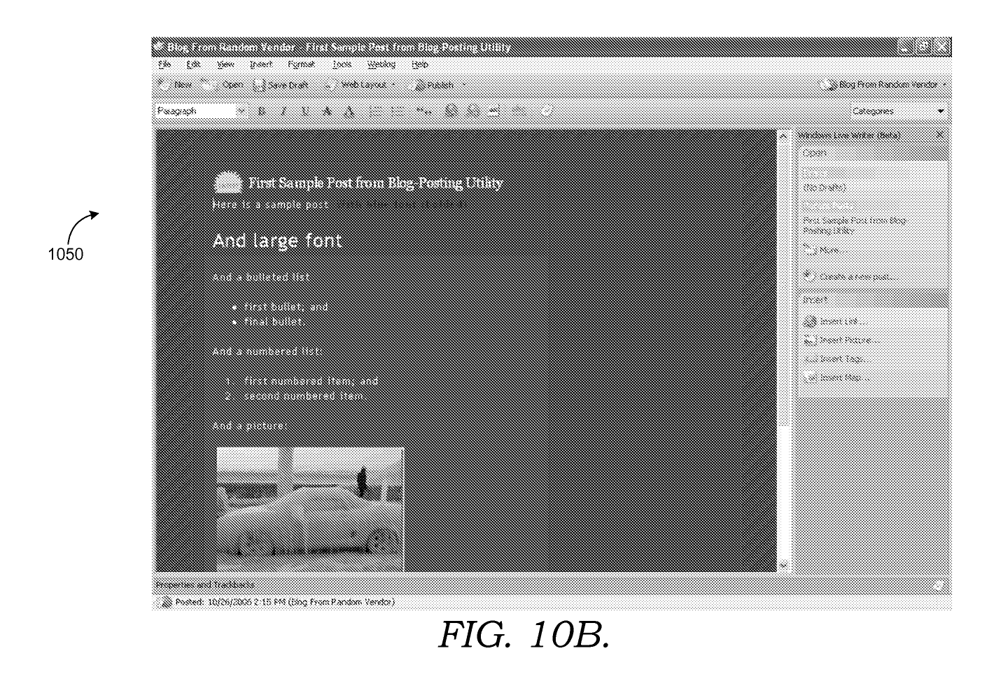

After a user indicates that he or she desires to update the editing environment (in the case where the manual process is not selected), editing environment 1010 is updated automatically to reflect the changes of FIG. 9A. In this way, the changes in a remote blog site are reproduced automatically in a local editing environment, such as that shown in screenshot 1000 of FIG. 10A. As shown, a piece of imagery 1012 is shown, which corresponds to the remote imagery referenced by numeral 910 in FIG. 9A.

Similarly, the title 1014 is now formatted to correspond to the format of the title 912 in FIG. 9A. Moreover, background formatting referenced by numerals 1016A and 1016B are also shown, which correspond in look and feel to the background depicted by numerals 914A and 914B in FIG. 9A. Similarly, if any other formatting options had changed in FIG. 9A (the remote blog site), those formatting options would be reflected in local editing environment 1010 of FIG. 10A.

As previously mentioned, media files such as image 1018 can be brought local to the client device to speed rendering in some embodiments. In other embodiments, the source code to render local editing environment 1010 may include a link, that when processed by application 124, presents a remote picture, such as a picture stored on the blog-service provider's website. In this way, if the picture ever changed on the remote blog-service provider's website, that change would be reflected immediately in local editing environment 1010. FIG. 10B depicts an actual screenshot 1050 of the drawing of FIG. 10A.

One of the benefits of an aspect of an embodiment of the invention is that it allows relatively easy insertion of rich content such as pictures, maps, photo albums, videos, sound clips, chat environments, source code, and the like into a blog post. Contemplating all of the various types of content (or objects) that blog authors might want to be able to insert into their posts is impractical. Accordingly, one aspect includes providing a process that allows for the insertion of an editable fragment of content (such as HTML or other type of content) into an editor that can be managed by externally loaded extensions (plugins) and that provides for alternate renderings of the content, or object(s), in different situations. Illustrative situations include an editing situation and a published or viewing situation.

By using an embodiment of the invention, users are able to extend the capability of blog service providers by creating and loading plugins that can be inserted as well as edited in a blog post. As previously mentioned, an embodiment of the invention offers the ability to associate a plugin (as well its metadata and supporting files if desired) with an editable code fragment in a blog-post editor along with the ability to allow a plugin to render a generated code fragment differently when a fragment is being edited in the editor versus when it is published and viewed in a web browser, for example.

As used herein, a “plugin” refers at least to a piece of code that can be packaged and run in connection with some other application. A plugin often takes the form of a library, such as a .DLL file that can be loaded into a running application (such as application 124) to augment the capabilities of that application. In one embodiment, plugins are loaded so that the editor may delegate the responsibility of maintaining a particular fragment of code, such as HTML, to the plugin. In such an embodiment, the plugin is responsible for presenting a user interface that allows users to customize content or objects generated from the code fragment. This may happen, for example, by way of an insertion command, an edit option presented via a dialog box, or through a control mounted on a side bar of the application, which will be discussed in greater detail below. This can also happen automatically, which will also be discussed in greater detail below.

In one embodiment, a media store is scanned to determine the presence of plugins, which are loaded into an application such as a blog editor (e.g., 124). An initialization process allows menus and keyboard commands associated with the plugins to be presented via application 124. Incident to an insertion or instantiation indication, application 124 will reference the relevant plugin, which will cause a user interface to be presented to receive settings that define characteristics associated with an object to be inserted into the blog post. The plugin may be provided a set of arguments to provide information about the insertion operation that will allow the plugin to change its logic based on the insertion context. A fragment of code, such as HTML or some kind of persistent metadata, will be used to generate a rendering that is inserted into the blog post while editing, and also into the blog post when published. The content fragment will be associated with the plugin so that future edits can be made to the fragment, and can be handled by the plugin.

After the rendering is inserted into the editing environment, the editor will invoke rendering methods on the plugin as necessary to keep other plugins' content current. Any changes that occur while editing the blog post that may require the plugin to update its content rendering will result in the invocation of methods of the plugin that allow it to refresh its HTML rendering in one embodiment. Illustrative examples of such situations include resizing, a change to a control characteristic, and the like. The rendering that is inserted is atomically selectable by a user.

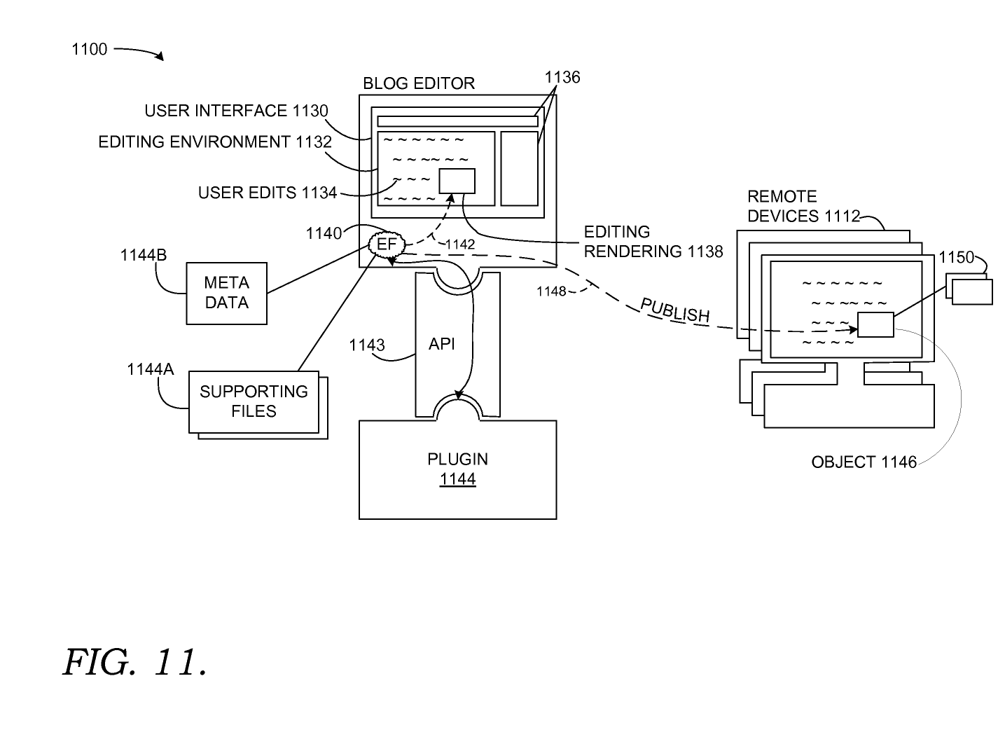

Turning now to FIG. 11, an illustrative operating environment is provided and referenced generally by the numeral 1100. In one embodiment, operating environment 1100 is similar to that of FIG. 1. In one embodiment, environment 1100 includes a user interface 1130 for developing and editing a blog post. User interface 1130, includes an editing environment 1132 in one embodiment. Controls 1136 may include things such as changing the font size or color, styles, paragraph formatting, and the like, as well as the respective plug-in's UI in some embodiments.

Editing environment 1132 includes a set of user edits 1134, which is the content that is to be included in a blog post, as well as a rendering 1138. More specifically, the rendering is referred to as “editing rendering 1138” because it is the rendering rendered in editing environment 1132. Rendering 1138 is generated based on an editable fragment of code 1140. Dashed line 1142 illustrates the concept that rendering 1138 is generated based on editable fragment 1140. Editable fragment 1140 is a bounded fragment of HTML or other code that is generated based on a plugin 1144, which, in one embodiment, is communicated with via an application program interface 1143. Plugin 1144 may be associated with one or more supporting files 1144A as well as metadata 1144B.

When a blog is posted, or published, editable fragment 1140 will be referenced in one embodiment to determine how to render object 1146, which is the published counterpart to rendering 1138, which exists in the editing environment, or an editing scenario. Dashed line 1148 conveys that editable fragment 1140 is used in connection, at least in part, to render object 1146 as well as control logic to perform whatever functions are supposed to be performed by object 1146. Supporting files or metadata that may be associated with object 1146 are shown and referenced by numeral 1150. For example, object 1146 may be intended to present a video. Object 1146, in such a situation, may be a picture, but associated with an video file, which would take the form of a supporting file 1150. Generally, published posts are viewed on remote devices 1112, but could also be viewed on the device hosting local editing environment 1132.

To provide additional detail associated with various aspects of the invention, we will know explain various illustrative processes associated with developing, inserting, editing, and publishing rich content associated with one or more blog posts. We will reference FIGS. 1, 11, 12, and 13.

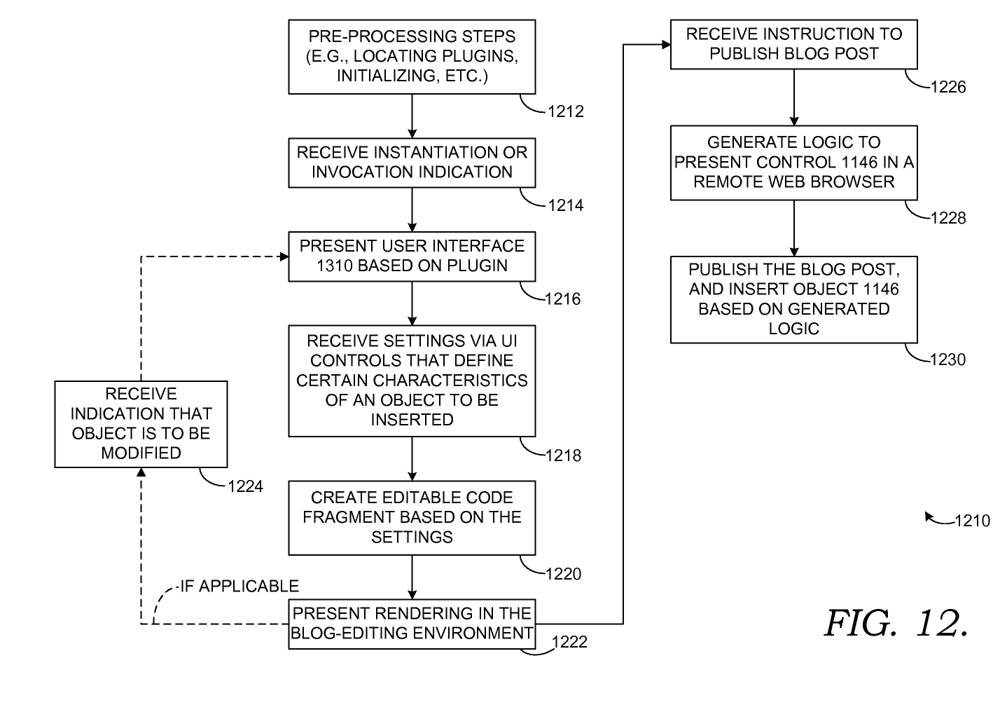

Turning now to FIG. 12, a pre-processing step is referenced by the numeral 1212. Illustrative steps carried out in the pre-processing feature include searching for available plugins, loading them, and preparing them for invocation. In some embodiments the plugins are automatically loaded and known by the blog-editing application. In other instances, they are searched for. And in still other instances, when a user attempts to invoke a plugin, the user can be prompted for information associated with locating a plugin. This latter process is beneficial in situations where the user knows the location of a plugin but the application does not.

In still other embodiments, blog-editing application 124 may be programmed to automatically search other remote locations that are periodically updated with new plugins 1144. Recall, one of the beneficial aspects of the invention is that it makes easy the process of utilizing a wide array of plugins 1144 that may be developed by hundreds or even thousands of different and disparate developers.

At a step 1214, a plugin-instantiation or invocation indication is received. This instantiation indication may be received in a variety of ways. A first way may include a user navigating a menu structure to insert or call upon a plugin, such as plugin 1144. A second way includes automatically sensing the applicability of a given plugin, and invoking that plugin. For example, a plugin may exist that makes easy the task of inserting video into a blog post. A user may attempt to drag and drop a video into editing environment 1132. As soon as the user attempts to drag and drop the video instance into editing environment 1132, the relevant plugin will be invoked automatically without a user having to navigate a menu structure or complete a corresponding key sequence.

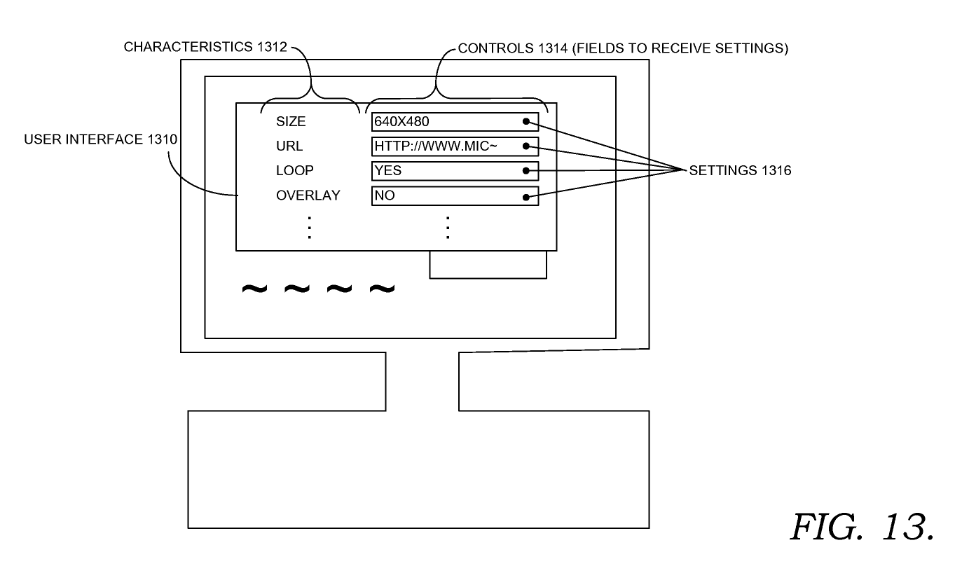

At a step 1216, a user interface based on the relevant plugin is presented. Turning briefly to FIG. 13, an illustrative user interface associated with a given plugin is provided and referenced generally by the numeral 1310. User interface 1310 presents a set of characteristics 1312 that will be associated or are associated with object 1146. User interface 1310 also includes a set of corresponding controls 1314 to receive user-defined settings 1316 that define characteristics 1312.

Returning to FIG. 12, at a step 1218, settings are received by way of controls 1314 that define the characteristics of an object such as object 1146 to be inserted ultimately into a remote post, but perhaps in place-holder form 1138 into editing environment 1132. The characteristics presented in a user interface such as user interface 1310 may vary according to the specific plugin. For example, if a plugin is associated with displaying a video clip, then characteristics associated with the video clip will be displayed. For example, size, frames per second, whether a clip is to be looped or not, etc., are types of examples that might be included.

But if plugin 1144 is associated with a map, for example, then characteristics may be along the lines of indicating a level of detail to be displayed, whether a satellite view is to be displayed, or whether a computer-generated view is to be displayed. Still further, if a plugin is associated with a photo album for example, then characteristics 1312 may include an indication of a number of thumbnails to show per row, or a resolution associated with each photograph. Whatever characteristics are relevant to whatever plugin is called will be displayed.

After the user's settings are received, editable fragment 1140 is created based on settings 1316 received. In some embodiments, editable fragment 1140 is created based on plugin 1144 as well as supporting files 1144A and metadata 1144B. Editable fragment 1140 is a fragment of code that, as previously explained, includes information associated with rendering the content or object to ultimately be rendered. Moreover, editable fragment 1140 includes information regarding how to display rendering 1138 in editing environment 1132. It can also include information on how to display object 1146, which may appear to be the same as rendering 1138 or very different, but which also may be associated with code necessary to provide the functionality associated with effecting object 1146.

Accordingly, rendering 1138 is presented in editing-environment 1132 at a step 1222. Rendering 1138 is a selectable object in editing environment 1132 that includes a bundled set of information that is easily accessible to a user. For example, if a user desires to edit any characteristics associated with the object (e.g. object 1146) ultimately to be rendered in a remote web page, they can do so by clicking rendering 1138. For example, in some embodiments, a user may be able to right click rendering 1138 to be presented with a shortcut menu that, for example, presents an “edit” option. Selecting the edit option will recall user interface 1310, whereby a user can update settings 1316 associated with rendering 1138, and/or object 1146. This process is referenced by step 1224, and can be repeated as often as a user desires to edit the rendering desired to be inserted into the blog post.

Other steps shown in FIG. 12 are publishing steps. At a step 1226, a command is received to publish a blog post developed in editing environment 1132. Incident to receiving this command, logic is generated at a step 1228 to present object 1146 so that it can be viewed in a remote web browser (implicitly shown as part of remote device 1112). This logic may take on a variety of forms.

For example, in one embodiment, the logic includes actual source code associated with presenting whatever functionality embedded in the source code of a web page that presents the remote blog post. In other embodiments, this logic includes a link to other programmatic code or supporting files, such as files 1150, that are used in connection with rendering object 1146. For example, it may be the case that a blog service provider may not want to actually host music, video, or other multimedia files because they are large—but in other instances the files themselves are actually uploaded and stored.

In such an example, providing a link to the actual file is known. A representation of the file may be presented along with logic that indicates what steps are to be followed in connection with activating object 1146. In some instances, this may take the form, for example, of displaying a picture that is hyperlinked to a video such that when a user clicks on the picture, a video is presented either in the web page or in a separate application such as a media-rendering application. An illustrative media-rendering application includes the Windows Media Player application developed by Microsoft Corporation of Redmond, Wash. At a step 1230, the local blog post is published and object 1146 is published as well according to the logic previously described.

Many different arrangements of the various components depicted, as well as components not shown, are possible without departing from the spirit and scope of the invention. For example, although an embodiment of the invention utilizes an Internet (or similar network, or portion thereof, but herein referred to generally as the “Internet”) link to initially gather information associated with presenting an editing environment, that may be only temporary; that is, the connection need only persist long enough to gather the information needed as described above. Accordingly, a live internet session is not needed to create, edit, and otherwise work on creating a blog post. And in some embodiments, there is specifically not a live Internet session. In such a situation, an embodiment of the invention can be practiced in what is termed a “non-live Internet session environment,” which is an environment that does not include nor rely on a live Internet session. Embodiments of the invention have been described with the intent to be illustrative rather than restrictive. Alternative embodiments will become apparent to those skilled in the art upon reading this disclosure.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media having computer-useable instructions embodied thereon for performing a method of editing a remote blog that has a certain appearance, the method comprising:
identifying a remote location associated with the blog that includes blog-rendering code that includes formatting code;
automatically creating a local instance of the blog-rendering code and a local instance of the formatting code; and
automatically utilizing the local instance of the blog-rending code and the local instance of the formatting code to present a local instance of an editing environment that substantially mirrors the appearance of the remote blog.

2. The media of claim 1, wherein the remote location includes one or more of:
a blog home page;
a wiki;
a website page that includes a blog; and
a portion of a website that includes at least one blog entry.

3. The media of claim 1, wherein the blog-rendering code includes a variation of a markup language source code.

4. The media of claim 3, wherein the variation of a markup language source code includes HTML (hypertext markup language).

5. The media of claim 1, wherein the formatting code includes one or more of:
a portion of the blog-rendering code; and
one or more formatting files accessible by the blog-rendering code.

6. The media of claim 5, wherein the portion of the formatting code includes CSS (cascading style sheet) code.

7. The media of claim 1, wherein the automatically creating includes copying to a user's machine:
at least a portion of the blog-rendering code; and
at least a portion of the formatting code.

8. The media of claim 1, wherein automatically utilizing comprises:
parsing the blog-rending code to identify structured regions associated with blog editing; and
recreating at least a portion of the structured regions in the editing environment to receive user input.

9. The media of claim 8, wherein to present a local instance of an editing environment includes:
locally replicating the appearance of the remote location; or
removing extraneous items from the remote location and presenting an editing environment that retains the formatting of the remote location.

10. The media of claim 1, further comprising:
utilizing the editing environment to receive user edits that create a blog post;
receiving an indication to publish the blog post to a user's remote blog service; and
automatically facilitating the posting of the blog post to the user's remote blog service.

11. The media of claim 10, further comprising:
receiving one or more indications to publish the blog post to multiple blog services; and
automatically facilitating the posting of the blog post to the multiple blog services.

12. A blog post composed by utilizing the computer-readable media of claim 1.

13. An editing template composed by utilizing the computer-readable media of claim 9.

14. One or more computer-readable media having computer-useable instructions embodied thereon for performing a method of editing a remote blog that has a certain appearance, the method comprising:
deriving an editing environment from the remote blog's appearance; and
automatically presenting the editing environment to a user such that user edits may be received and presented as they will appear when posted consistent with the certain appearance.

15. The media of claim 14, wherein deriving an editing environment from the remote blog's appearance comprises:
posting a temporary blog post to a user's remote blog service that includes one or more identifiable tokens inserted into one or more structured regions;
downloading blog-rendering information associated with the remote blog service;
utilizing the identifiable tokens to determine from the blog-rendering information, one or more structured regions associated with the blog post;
reproducing the structured regions in the editing environment; and
utilizing the downloaded blog-rendering information to format the editing environment to match the remote blog's appearance.

16. The media of claim 15, wherein the blog-rendering information includes one or more of:
blog-rendering source code;
formatting information; and
media components.

17. The media of claim 16, wherein the formatting information includes one or more selections from the following:
paragraph formatting information;
font formatting information;
structured-list formatting information including bulleted lists and numbered lists;
page formatting information; and
combinations thereof.

18. The media of claim 16, wherein the media components include one or more of:
a picture;
a sound;
a video; and
combinations thereof.

19. The media of claim 14, wherein deriving an editing environment from the remote blog's appearance comprises:
requesting that a user's blog service retrieve information associated with a remote blog post;
identifying from the information, identifiers respectively associated with structured regions of the post; and
utilizing the identifiers to identify the structured regions; and
recreating the structured regions locally.

20. One or more computer-readable media having computer-useable instructions embodied thereon for performing a method of editing a remote blog that has a certain appearance, the method comprising:
identifying a remote blog site, the remote blog site having an appearance;
determining what information blog-rendering code is associated with presenting the blog site in such a way to have the appearance; and
utilizing the information to present an editing environment with a format that substantially corresponds to the appearance.
